(19) United States
(12) Patent Application Publication
(10) Pub. No.: US 2003/0090513 A1
(43) Pub. Date: May 15, 2003

(54) Information personalization by partial evaluation

(76) Inventor: Narendran Ramakrishnan, Blacksburg, VA (US)

Correspondence Address: LAW OFFICES, WHITHAM, CURTIS & CHRISTOFFERSON, P.C., 11491 SUNSET HILLS ROAD, SUITE 340, P.O. Box 9204, RESTON, VA, 20190, US

(21) Appl. No.: 09/986,733

(22) Filed: Nov. 9, 2001

(51) Int. Cl. G09G 5/00

(52) U.S. Cl. 345/744

(57) ABSTRACT

A systematic modeling methodology for information personalization automatically adjusts information content, structure, and presentation to an individual user of the information. Termed PIPE (Personalization is Partial Evaluation), the invention makes no commitments to a particular algorithm, format for information resources, type of information-seeking activities or, more basically, the nature of personalization delivered. Instead, it emphasizes the modeling of an information space in a way where descriptions of information-seeking activities can be represented as partial information. Such partial information is then exploited (in the model) by partial evaluation, a technique popular in the programming languages community.

### BACKGROUND OF THE INVENTION

1. Field of the Invention

The present invention generally relates to information personalization in computerized information systems and, more particularly, to a systematic modeling methodology for personalization by which personalization systems may be designed and implemented by modeling an information-seeking interaction in a programatic representation. The representation supports the description of information-seeking activities as partial information and their subsequent realization by partial evaluation.

2. Background Description

One of the main contributions of information systems research is the development of models that allow the specification and realization of information-seeking activities. Besides formalizing important operations, such models provide a vocabulary with which to reason about the information-seeking activity. For instance, if an information space is modeled as a term-document matrix, then the vector-space model permits the view of retrieval as measuring similarities between document vectors. Similarly, the modeling of data as a set of relations in a database system affords expressive query languages such as SQL. Other models and modeling methodologies can be found in interactive information retrieval applications (see, for example, D. R. Cutting, D. Karger, J Pederson, and J. W. Tukey, “Scatter/Gather: A Cluster-Based Approach to Browsing Large Document Collections”, Proceedings of the Fifteenth Annual International Conference on Research and Development in Information Retrieval (SIGIR), pp. 318-329, Copenhagen, Denmark, 1992, G. M. Sacco, “Dynamic Taxonomies: A Model for Large Information Bases”, IEEE Transactions on Knowledge and Data Engineering, Vol. 12(3): pp. 468-479, May/June 2000, and M. D. Williams, “What makes RABBIT run?”, International Journal of Man-Machine Studies, Vol. 21: pp. 333-352, 1984).

Personalization constitutes the mechanisms and technologies required to customize information access to the end-user. It can be defined as the automatic adjustment of information content, structure, and presentation tailored to an individual user. The reader will be familiar with instances of personalization such as web sites that welcome a returning user and recommender systems (see G. Adomaviciius and A. Tuzhilin, “Using Data Mining Methods to Build Customer Profiles”, IEEE Computer, Vol. 34(2): pp. 74-82, February 2001, and P. Resnick and H. R. Varian, “Recommeder Systems”, Communications of the ACM, Vol. 40(3): pp. 56-58, 1997) at sites such as amazon. com. The scope of personalization today extends beyond web pages and web sites (L. Terveen, W. Hill, and B. Amento, “Constructing, Organizing, and Visualizing Collections of Topically Related Web Resources”, ACM Transactions on Computer-Human Interaction, Vol. 6(1): pp. 67-94, March 1999) to many different forms of information content and delivery (see, for example, K. Claypool, L. Chen, and E. A. Rudensteiner, “Personal Views for Web Catalogs”, IEEE Data Engineering Bulletin, Vol. 23(1): pp. 10-16, March 2000, P. B. Kantor, E. Boros, B. Melamed, V. Menkov, B. Shapira, and D. J. Neu, “Capturing Human Intelligence in the Net”, Communications of the ACM, Vol. 43(8): pp. 112-115, August 2000, and P. Maglio and R. Barrett, “Intermediaries Personalize Information Streams,” Communications of the ACM, Vol. 43(8): pp. 96-101, August 2000). The underlying algorithms and techniques range from simple keyword matching of consumer profiles, to explicit (C. C. Aggarwal, J. L. Wolf, K.-L. Wu, and P. S. Yu, “Horting Hatches an Egg: A New Graph-Theoretic Approach to Collaborative Filtering”, Proceedings of the Fifth ACMSIGKDD Conference on Knowledge Discovery and Data Mining (KDD '99), pp. 201-212, San Diego, Calif., 1999, J. A. Konstan, B. N. Miller, D. Maltz, J. L. Herlocker, I. R. Gordon, and J. Riedl, “GroupLens: Applying Collaborative Filtering to Usenet News”, Communications of the ACM, Vol. 40(3): pp. 77-87, March 1997, and L. Terveen, W. Hill, B. Amento, D. W. McDonald, and J. Creter, “PHOAKS: A System for Sharing Recommendations”, Communications of the ACM, Vol. 40(3) pp. 59-62, March 1997) or implicit (B. Mobasher, R. Cooley, and J. Srivastava, “Automatic Personalization Based on Web Usage Mining”, Communications of the ACM, Vol. 43(8): pp. 142-141, August 2000, and M. Spiliopoulou, “Web Usage Mining for Web Site Evaluation”, Communications of the ACM, Vol. 43(8): pp. 127-134, August 2000) capture of user interaction.

Despite its apparent popularity in reducing information overload on the Internet, personalization suffers from a lack of any rigorous model or modeling methodology. One of the main reasons is that there are personal views of personalization (see D. Riecken, “Personalized Views of Personalization”, Communications of the ACM, Vol. 43(8): pp. 26-28, 2000). There are hence as many ways to design and build a personalization system as there are interpretations for what personalization means. Such a diversity presents a difficulty when studying conceptual models of personalization, in general.

As a motivating example, consider a consumer visiting an automobile dealership to purchase a vehicle. Here are two possible scenarios.

Scenario 1

Dealer: Madam, are you looking to purchase a passenger vehicle?

Buyer: Yes.

Dealer: Do you have a particular manufacturer in mind?

Buyer: I know that cars made by Honda have the highest safety approval rating.

Dealer: That is true. Honda comes in seven colors. Do you have a preference for color?

Buyer: The “cyclone blue” looks pleasing.

(The conversation continues to ascertain further details of the vehicle.)

Scenario 2

Dealer: Sir, may I interest you in anything?

Buyer: I am looking for a sport utility vehicle.

Dealer: Sure, do you have a particular manufacturer in mind?

Buyer: Not really, but the vehicle should be Red and made in 2001.

Dealer: I see.

Buyer: And by the way, I don't care for the fancy doormats and fittings.

Dealer: Of course.

(The conversation continues.)

In the first scenario, the conversation is directed by the dealer, and the buyer merely answers questions posed by the dealer. The second scenario resembles the first up to a point, after which the buyer takes the initiative and provides answers “out of turn.” When queried about manufacturer, the buyer responds with information about color and year of manufacture instead. Nevertheless, the conversation is not stalled and both parties continue the dialog to (eventually) complete the information assessment task. At each stage in the above conversations, the buyer has the choice of proceeding along the lines of inquiry initiated by the dealer or can shift gears and address a different aspect of information assessment. Scenarios that ‘mix’ these two modes of inquiry in such arbitrary ways constitute the scope of mixed-initiative interaction (D. G. Novick and S. Sutton, “What is Mixed-Initiative Interaction?”, in S. Haller and S. McRoy, editors, Proceedings of the AAAI Spring Symposium on Computational Models for Mixed Initiative Interaction, AAAI/MIT Press, 1997).

Can we support a similar diversity of interaction in an online information system? In other words, the system should have a default mode of interaction where a user would fill in forms (or click on choices) in a specified order. A more enterprising user should be able to supply any piece of information out of turn. Finally, it should be possible to mix these two modes of interaction in any order. At each stage of the interaction (whether system-initiated or user-requested), the system should respond with the appropriate set of choices available. For instance, notice the restriction to seven colors once the decision on Honda is made in Scenario 1. If the choice of color was made at the outset, presumably more selections would have been available. A system that supports such a diversity of interaction would be personalized to a user's individual preference(s) for information-seeking.

The typical solution involves anticipating the forms of interactions that have to be supported and designing interfaces to support the implied scenarios (we use the term “scenarios” to mean scenarios of interaction). FIGS. 1A, 1B, 1C, and 1D illustrate four typical solutions that make various assumptions on the scenarios that will be supported. FIG. 1A can only support situations such as Scenario 1 above, in that the user is forced to make a choice of manufacturer at the outset (and all remaining levels are similarly fixed). We refer to this as a design that hardwires scenarios. FIG. 1B also hardwires scenarios, but provides a choice of two such hardwired scenarios (i.e., search by model or search by price). FIG. 1C is what we refer to as complete enumeration, which involves enumerating all possible scenarios and providing interfaces to all of them (see, M. Hearst, “Next Generation Web Search: Setting Our Sites”, IEEE Data Engineering Bulletin, Vol. 23(3): pp. 38-48, September 2000). While the interface in FIG. 1C only depicts the top-level choice, we could imagine that such multiplicity of choices are duplicated at all lower levels. It is clear that enumeration could involve an exponential number of possibilities and correspondingly cumbersome site designs. And finally, FIG. 1D provides the same functionality as FIG. 1C but masks the details of enumeration in a convenient “power-search” form.

All of these solutions rely on anticipating the points where an out-of-turn interaction can occur and provide mechanisms to support it. When opportunities for out-of-turn interaction are too restrictive, information systems cause major frustrations to users. The bask problem is the representational mismatch between the user's mental model of the information-seeking activity and the facilities that are available for describing the activity.

In FIG. 2, the user is attempting to decide on an automotive retailer based on the services offered. He is open to the possibility of traveling to a different city in order to make his purchase. He is thus unsure of providing information about the location of the retailer, but the system insists that he make this choice first. The reader can identify with examples such as these from other personal experiences.

### SUMMARY OF THE INVENTION

It is therefore an object of the present invention to provide a modeling methodology for information personalization.

It is another object of the invention to provide a design approach that promotes out-of-turn interaction without predefining the points where such interaction can take place.

It is yet another object of the invention to provide a personalization system which does not anticipate in advance the ways in which an out-of-turn interaction can take place.

It is a further object of the invention to provide a method of information personalization which enables mixed-initiative interaction without hardwiring the ways in which the initiative could be mixed.

According to the invention, there is provided a systematic modeling methodology for information personalization. Termed PIPE (Personalization is Partial Evaluation), the invention makes no commitments to a particular algorithm, format for information resources, type of information-seeking activities or, more basically, the nature of personalization delivered. Instead, it emphasizes the modeling of an information space in a way where descriptions of information-seeking activities can be represented as partial information. Such partial information is then exploited (in the model) by partial evaluation, a technique popular in the programming languages community (see N. D. Jones, “An Introduction to Partial Evaluation”, ACM Computing Surveys, Vol. 28(3): pp. 480-503, September 1996).

In the practice of the invention, the following steps are performed. First, the information-seeking interaction sequences with the information system are modeled so that each interaction sequence denotes a possible dialog between the user and the information system. Optionally, the interaction sequences are compacted to determine a new set of interaction sequences having fewer states. Second, a computer program is used to programmatically represent the interaction sequences. Third, a personalization system is created by partial evaluation of the computer program to generate a simplified program. Fourth, a personalized information space is generated for the user in a user interface from the simplified program.

While the invention and results apply to many forms of computerized information systems (e.g. web-based, voice-activated), the preferred embodiment of the invention is directed to web sites. However, as shall be illustrated, the range of information systems technologies to which PIPE can be applied is not so limited. Any information system technology that permits a programmatic modeling of interaction can be personalized with PIPE. For instance, PIPE can be applied to voice-activated applications, Lightweight Directory Access Protocol-driven directory access, and automated information kiosks. In other words, PIPE can be applied to any technology that supports programmatic modeling.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A, 1B, 1C, and 1D are screen prints illustrating examples of organizing web catalogs;

FIG. 2 is a screen print illustrating an interface that prohibits certain information-seeking activities from being described;

FIG. 3 is an illustration of the partial evaluation technique written in the C programming language;

FIGS. 4A and 4B illustrate personalizing a browsing hierarchy by contrasting an original information resource (FIG. 4A) with a personalized hierarchy (FIG. 4B);

FIG. 5 illustrates using partial evaluation for personalization in the C programming language;

FIG. 6 is a diagram illustrating a PIPE interface to a traditional browser;

FIG. 7 illustrates choices for representing aspects of interaction in PIPE;

FIG. 8 illustrates modeling information integration in PIPE in the C programming language;

FIGS. 9A, 9B, 9C, and 9D are diagrams illustrating four stages in extracting structure from a semistructured data source;

FIGS. 10A, 10B, and 10C are screen prints showing a typical interaction sequence at the Project Vote Smart web site; and

FIG. 11 is a flow diagram showing the steps in the PIPE methodology.

### DETAILED DESCRIPTION OF A PREFERRED EMBODIMENT OF THE INVENTION

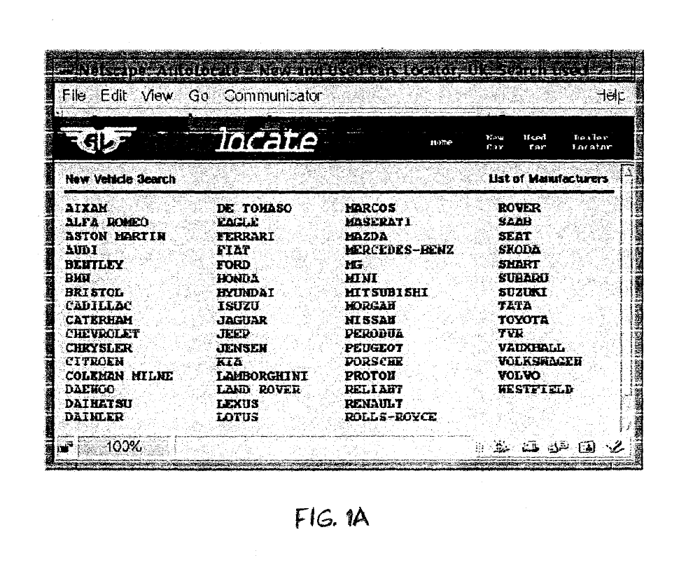

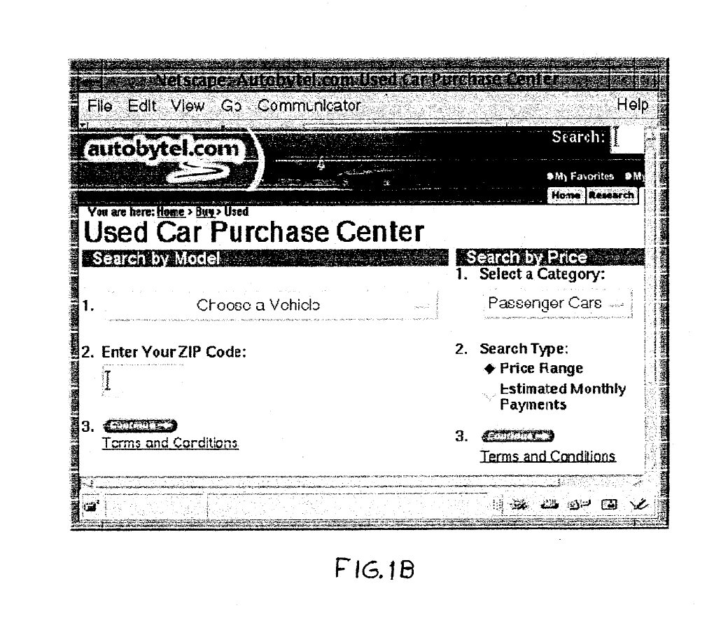

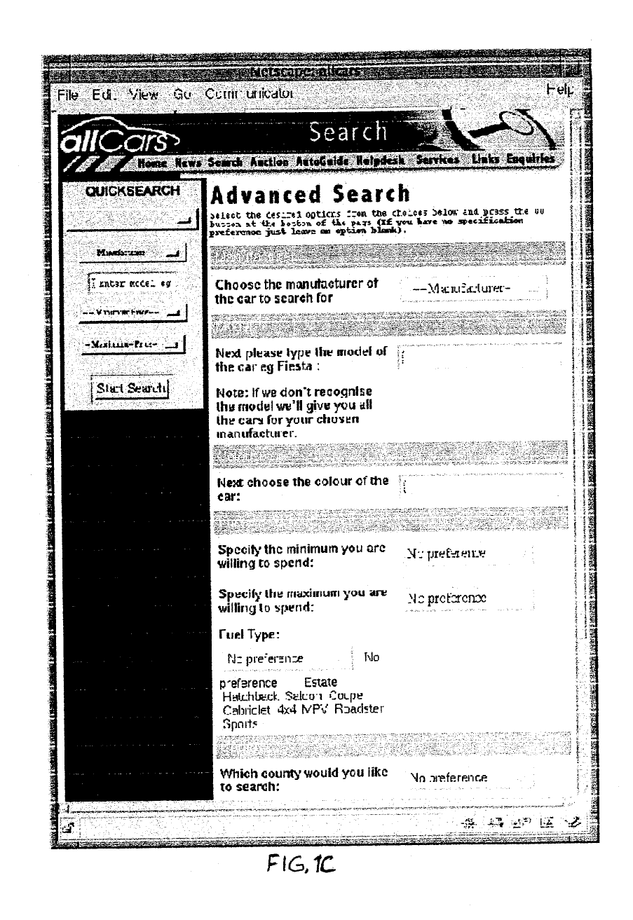

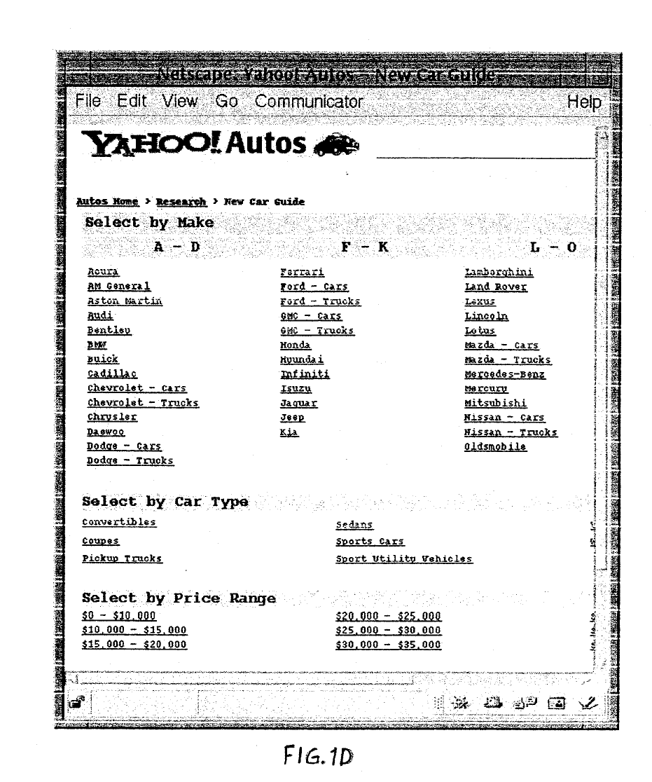

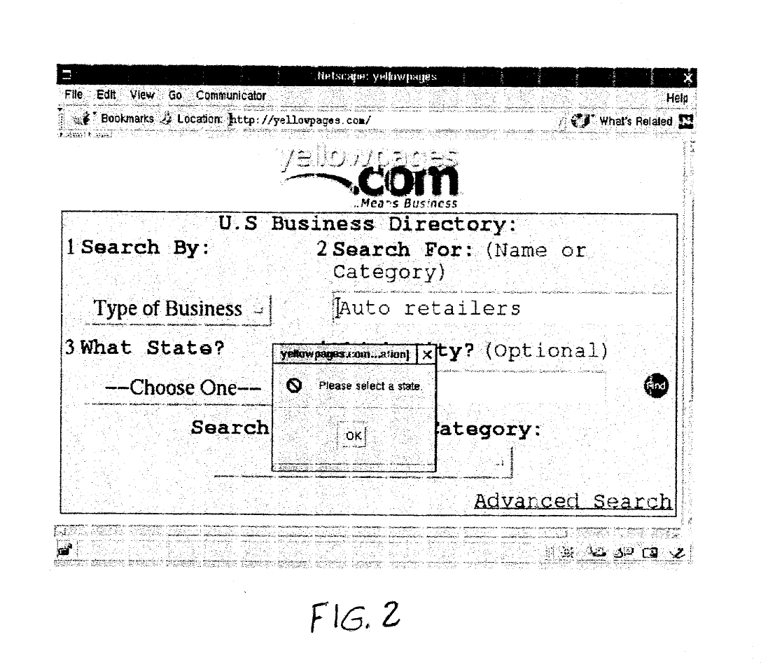

The invention's approach to information personalization is presented, and that promotes out-of-turn interaction without predefining the points where such interaction can take place. Consequently, the interfaces produced by the invention are, at once, both more expressive and simpler than the ones in FIGS. 1A, 1B, 1C, or 1D.

Let us begin by considering the scenario where a user obediently supplies information attributes in the order requested. For ease of presentation, it is assumed that there are three attributes—color, year of manufacture, and manufacturer—and that the information system ascertains values for them in this order. The key contribution of PIPE (Personalization is Partial Evaluation) is to cast this seemingly inflexible and hardwired scenario in a representation that allows its automatic transformation into other scenarios. In particular, PIPE represents an information space as a program, partially evaluates the program with respect to (any) user input, and recreates a personalized information space from the specialized program.

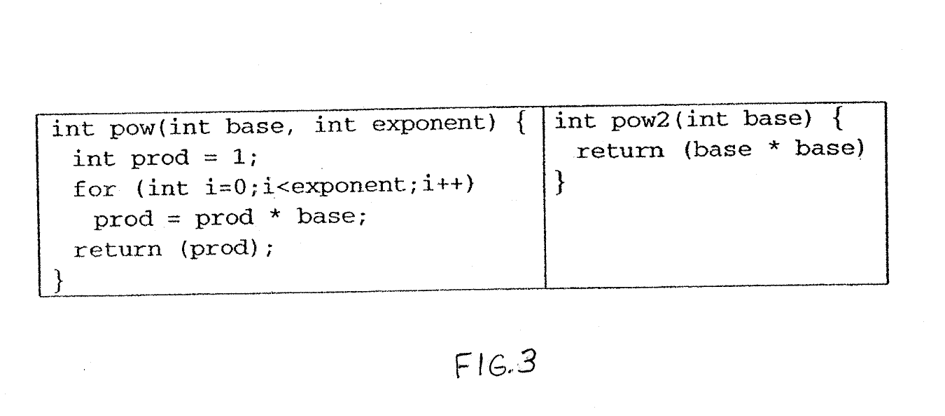

The input to a partial evaluator is a program and (some) static information about its arguments. Its output is a specialized version of this program (typically in the same language), that uses the static information to “pre-compile” as many operations as possible. A simple example is how the C programming language function pow can be specialized to create a new function, say pow2, that computes the square of an integer is illustrated in FIG. 3. A general purpose power function is written in C in the left, and its specialized version (with exponent statically set to 2) to handle squares is written in the right. Such specializations are performed automatically by partial evaluators such as C-Mix. Consider, for example, the definition of a power function shown in the left part of FIG. 3. If it were known that a particular user will utilize it only for computing squares of integers, it could be specialized (for that user) to produce the pow2 function. Thus, pow2 is obtained automatically (not by a human programmer) from pow by pre-computing all expressions that involve exponent, unfolding the for-loop, and by various other compiler transformations such as copy propagation and forward substitution. Automatic program specializers are available for C, FORTRAN, PROLOG, LISP, and several other important computer languages. The interested reader is referred to N. D. Jones, “An Introduction to Partial Evaluation”, ACM Computing Surveys, Vol. 28(3): pp. 480-503, September 1996, for a good introduction. While the traditional motivation for using partial evaluation is to achieve speedup and/or remove interpretation overhead it can also be viewed as a technique for simplifying program presentation, by removing inapplicable, unnecessary, and “uninteresting” information (based on user criteria) from a program.

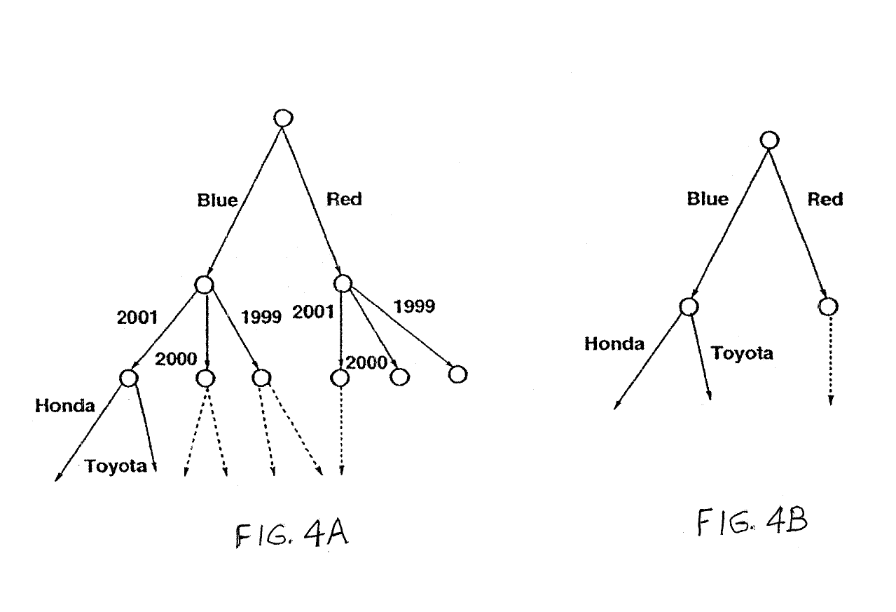

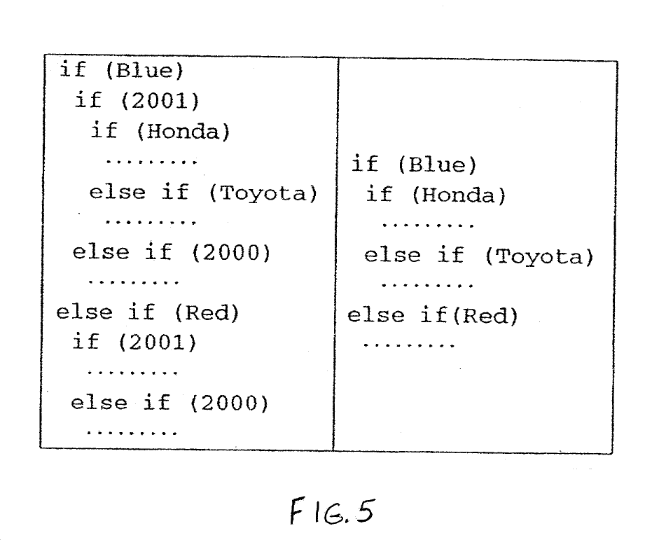

Consider the hardwired scenario depicted in FIG. 4A. This hierarchy can be abstracted by the program below whose structure models the information resource (in this case, a hierarchy of web pages) and whose control-flow models the information-seeking activity within it (in this case, browsing through the hierarchy by making individual selections). The link labels are represented as program variables and semantic dependencies between links are captured by the mutually-exclusive if . . . e 1 s e dichotomies. As it is modeled in FIG. 5, the program reflects the assumption that the choice of year is usually made at the second level, after a color selection has been made. However, to personalize for the user who says “2001” at the outset, the program is partially evaluated with respect to the variable 2001 (setting it to one and all conflicting variables such as 2000 to zero). This produces the simplified program on the right side of FIG. 5, which can be used to recreate web pages with personalized web content (shown in FIG. 4B). The second level of the hierarchy is simplified, bringing the originally third level as the new second level. The user is able to provide the value of any deeply nested variable out of turn, thus achieving mixed-initiative interaction. Personalization systems are thus designed and implemented in PIPE by modeling an information-seeking interaction in a programmatic representation.

The PIPE methodology is now described in more detail and choices available are outlined for modeling typical situations. While partial evaluation permits formal specification with mathematical notation (see, N. D. Jones, Computability and Complexity: From a Programming Perspective, MIT Press, Cambridge, Mass., 1997), this approach is not taken here. Instead, the larger context in which partial evaluation is used in PIPE is emphasized and its advantages for information systems are described.

As a modeling methodology, PIPE only makes the weak assumption that information is organized along a motif of interaction sequences. For purposes of this description, an interaction sequence is a list of primitive inputs used to describe the information-seeking activity. For instance in FIG. 5, information about vehicles is organized along a color-year-model motif with the primitive inputs corresponding to specific choices of color, year, or model. The interaction sequence in this example involves the the choice of 2001 for year, in support of the user's goals.

Information is embodied in an interaction sequence in two forms—structural and terminal. Structural information is what helps us refer to an interaction sequence; it is explicitly represented in PIPE and specified via program variables. In FIG. 5, the structural information corresponds to choices of color, year, and model. This form of information thus captures the partial information supplied by the user by instantiating parts of the motif. When the user specifies “2001” in FIG. 5, the year part of the motif is turned on and set to this value.

Terminal information is also represented in PIPE, but is not directly manipulatable or even directly addressable. Programs in PIPE are not explicitly parameterized by this information and so the user cannot specify personalization in these terms. In FIG. 5, terminal information corresponds to the leaves, which would be information about particular vehicles. In a different application, terminal information could reside at every step in the interaction sequence. Structural information thus provides the “backbone” that strings together terminal information.

Since PIPE only emphasizes the design and implementation of personalization systems, it does not pay any attention to how the interaction sequences are obtained and how the choice between terminal and structural parts is made. In particular, PIPE is not a complete life cycle model for personalization system design and does not address issues such as requirements gathering. Interaction sequences could come from explaining users' behavior (see, for example, N. Ramakrishnan, M. B. Rosson, and J. M. Carroll, “Explaining Scenarios for Information Personalization”, ACM Transactions on Computer-Human Interction, August 2001, and A Wexelblat and P. Maes, “Footprints: History-Rich Tools for Information Foraging, Proceedings of the ACM Conference on Human Factors in Computing Systems (CHI'99), pp. 270-277, Pittsburgh, Pa., 1999), by identifying all possible paths through a given site, or from a conceptual understanding of the information-seeking activity. They also depend on the targeting goals of the personalization system. In N. Ramakrishnan et al., supra, there is presented a systematic methodology for obtaining interaction sequences and identifying structural and terminal parts, by “operationalizing” scenarios of interaction; the reader is referred to this reference for details. In this description, it is assumed that they are available and they are further characterized and represented.

Given that information-seeking activities can be represented as interaction sequences, the set of scenarios that are likely to be encountered (over all users, perhaps) can be represented by a corresponding set of interaction sequences. Once again, PIPE does not indicate what the set of interaction sequences should be; i.e., whether it is defined across all users whether it is for a group of users, or whether it comes from a conceptual understanding of information-seeking. PIPE only emphasizes the representation of interaction sequences in a programmatic representation.

For instance, FIG. 5 uses a nested representation to form the program for subsequent partial evaluation. Not only does it model the color-year-model motif (as it would have been observed), it also allows us to model the year-color-model motif (by one partial evaluation). Since PIPE provides out-of-turn interaction, it is not necessary to represent every interaction sequence explicitly in the program.

Such compaction of interaction sequences is important for two reasons. The first is that it preserves the inherent structure of the (unpersonalized) information-seeking activity (such as browsing, in FIG. 5). This is useful in realizing mixed-initiative interaction with PIPE. Another reason is that compaction permits scalable personalization solutions.

Structural parts of interaction sequences can be represented using constructs in a full-fledged programming language, such as the C programming language (as done in FIG. 5) or the LISP programming language. A programming language provides many facilities that can help in compaction of interaction sequences. For example, if it is noticed that all interaction sequences at a site require registration at some point in the interaction, then the steps associated with registration could be factored out and procedurally invoked from various other locations. Off-the-shelf partial evaluators (such as C-Mix) can then be used for specializing the representations.

It is important also to model terminal parts of interaction sequences. In the example of FIG. 5, if there is text anchoring every hyperlink, then a program variable can be defined to start accumulating text once every conditional is evaluated to be true. This could be achieved using associative arrays or by dynamic memory allocation constructs (e.g., pointers). After partial evaluation, the contents of this data structure can be inspected at every stage to present personalized (terminal) content. Inspecting the contents of the sequence as a whole will provide an overall summary of the terminal information. Inspecting the contents of subsequences will provide more fine-grain summaries of terminal information.

To effect the creation of a personalization system, ways for the user to specify values for program variables are defined and a procedure by which personalized information content is presented back to the user is provided. Every construct used in the programmatic modeling (terminal or structural) should be translatable into information systems terms, and vice versa.

Typically, there is a one-one mapping between interactions and programming constructs. In FIG. 7, the textbox corresponds to a conditional, the listbox to a switch construct, and the unit convertor to a function in a PIPE modeling.

Such mappings have to be revisited after partial evaluation. For instance, the if construct in FIG. 7 will either be removed or left as-is by a partial evaluation. This will just correspond to removing or retaining the text box in the personalized web site. The switch construct in FIG. 7 corresponding to a list box is more interesting. After partial evaluation, it might be the case that only one of the three topping options are left. Perhaps the person is allergic to mushrooms and olives and those variables are set to zero. In this case, the partial evaluator might remove the switch altogether and replace it with a simple if. This can be viewed as a hint to render the list box as a hyperlink in the personalized site. Finally, the unit conversion utility in FIG. 7 can be modeled in several ways. It can be viewed as a functional black-box and model in PIPE the act of getting a value and passing it to, say, a server-side script that performs the conversion. If this approach is taken, it should be ensured that partial evaluation either retains the black-box representation or removes it; it should not “open” it up. Alternatively, this black-box can be explicitly opened up and its contents modeled as a function in a PIPE modeling (as done in FIG. 7). As a functional modeling. PIPE thus enables the view of information systems as transducers.

An important advantage of PIPE is that while providing options for modeling, there is no explicit step for describing how to implement personalization. Due to the sophistication of the representation, personalization will be achieved if program variables (which correspond to structural information) are available for partial evaluation. This is in contrast to other modeling methodologies where personalization has to be provided as an explicit function from the conceptual design stage.

The primary example of modeling thus far addressed navigation down a hierarchy via nested conditionals (see FIG. 5). This is one of the most common sources of bounded sequences; it can be obtained either by explicit crawling or as graph representations of site structure from website management tools. In the former, extra care should be used to address purely navigational links (like a “Go Back” button) and irregularities in web page authoring. Representations obtained from the latter case are more robust since they directly enable the modeling of interaction sequences in terms of directed labeled graphs or web schema. A number of other modeling options for personalization applications can be described by bounded interaction sequences.

A recommender system can be viewed in PIPE as a way to set values for program variables or as a function to be modeled. In the first case, the recommender is abstracted as a black-box and is external to. the program. Consider a recommender system at a third-party site that suggests automobile dealers based on experiences of its users. In such a case, the facility can be invoked to obtain values for program variables which are then subsequently used for personalization. Alternatively, the functioning of the recommender can be explicitly modeled in PIPE. This allows the possibility that even its operation could be personalized. For instance, if the recommender system can suggest dealers all across the United States, it is possible to personalize its operation to only recommend dealers in a particular geographical region. This will not be possible in the black-box modeling unless the recommender allows such explicit specification.

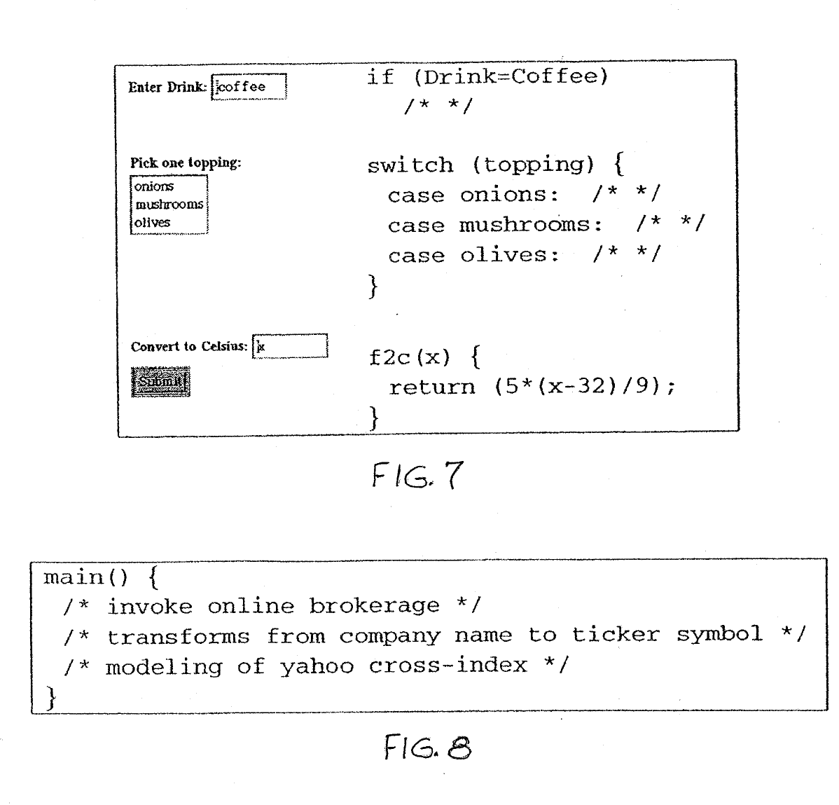

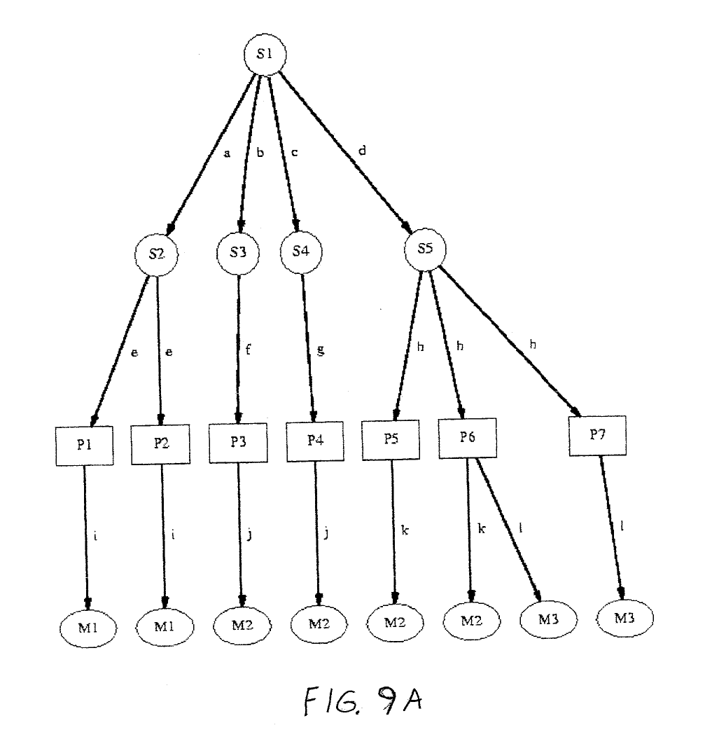

Effective personalization scenarios require the integration of information from multiple sites. Consider personalizing stock quotes for potential investors. The Yahoo! Finance Cross-Index at quote.yahoo.com provides a ticker symbol lookup for stock charts, financial statistics, and links to company profiles. It is easy to model and personalize this site by the methods described above. However, consider the user who desires to browse through this site based on recommendations from an online brokerage. Besides supporting the cascading of information flows, it is necessary to ensure that structural information across multiple sites is correctly cross-referenced. The online brokerage might refer to its recommendations by company name (e.g., “Microsoft”), while the Yahoo! cross-index uses the ticker symbol (“MSFT”). Information integration solutions based on wrappers and mediators can be employed here. In PIPE, the individual interaction sequences from multiple sites can be cascaded to provide support for such integration scenarios, as shown in FIG. 8.

Many web sites provide clickable image maps (e.g., JAVA/GIF) as interfaces to information. This is especially true for weather sites, bioinformatics resources, and sites that involve modeling spatial information. Interpretation is attached to clicking on particular locations of the map (for instance, “click on the state for which you would like the weather”). Using data mining techniques and by sampling clicks on the map (and determining which pages they lead to), it is possible to functionally model a clickable map in PIPE to arrive at constructs such as: “Choosing Wyoming on the United States map corresponds to clicking within (a, b)×(c, d)”. Non-rectangular areas are described by unions of isothetic regions by the data-mining technique described in T. Fukuda, Y. Morimoto, S. Morishita, and T. Tokuyama, “Mining Optimized Association Rules for Numeric Attributes”, Journal of Computer and Systems Sciences, Vol, 58(1): pp. 1-12, 1999. Given such a representation, partial evaluation can remove portions of the image map based on user preferences. At this stage, a personalized clickable map can be reconstructed by reversing the mapping or use attributes such as color and shade to highlight the selected regions (for instance, to show only those regions on the map where air travel is delayed). The personalized information also can be represented in non-graphical terms. This option is useful not just for personalization but for improving the accessibility of information systems. A mobile handheld device incapable of presenting graphical content can take advantage of such modeling.

In some cases, it is necessary to model interaction sequences within a web page. For instance, if a user is eyeballing a web page to look for telephone numbers of an individual, then modeling the web page at this level of granularity and providing a program variable for telephone number would be useful. Algorithms for mining structure within a web page (e.g., Document Type Definitions or DTDs) and for document segmentation can be used to arrive at compact representations of within-page interaction sequences. This provides a richer set of features with which to conduct personalization. For instance, partial evaluation can be used to remove complete sections of documents (e.g., intrusive advertisement banners) when rendering the personalization.

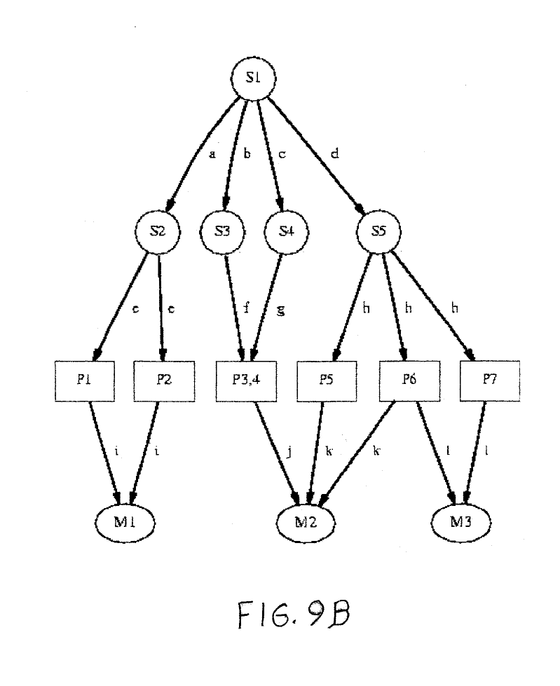

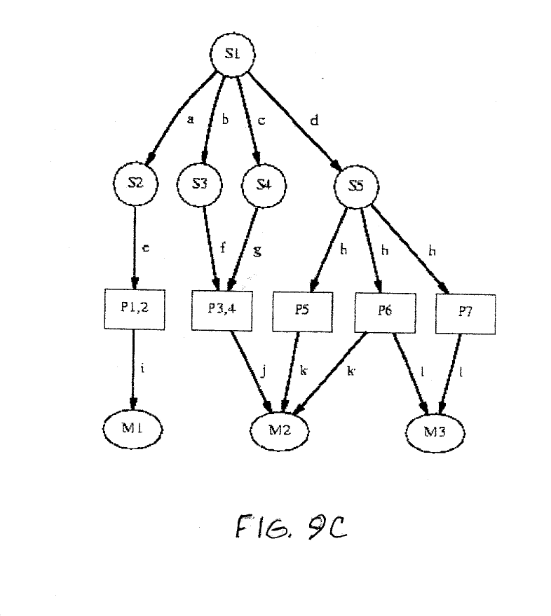

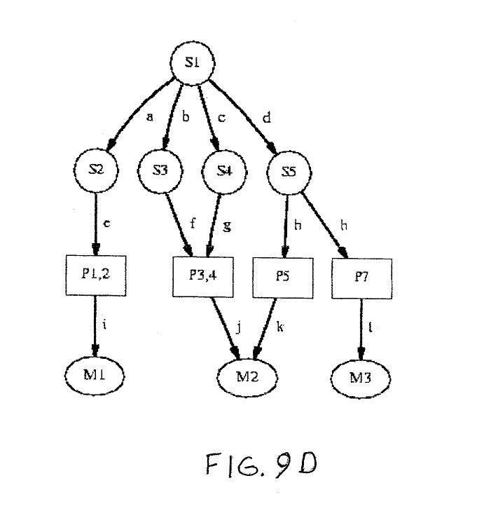

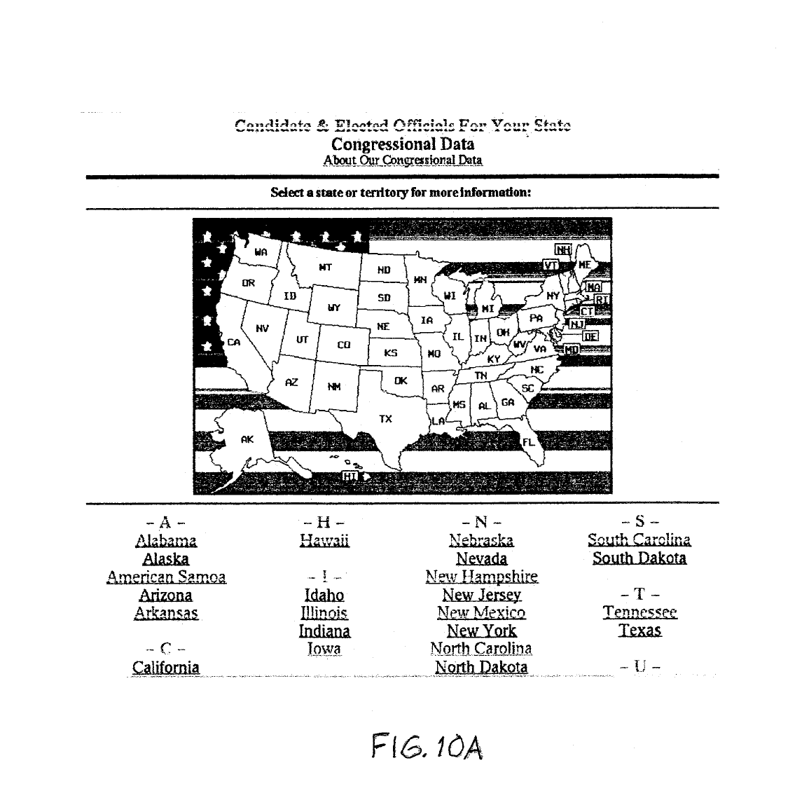

The naive rendition of a PIPE model by the above mechanisms might result in lengthy programs, with duplications of interaction sequences. Techniques for program compaction are hence important. This topic has been studied extensively in the data mining and semistructored modeling communities (see, for example, S. Abiteboul, P. Buneman, and D. Suciu, Data on the Web: From Relations to Semistructured Data and XML, Morgan Kaufman Publishers, 2000, S. Nestorov, S. Abiteboul, and R. Motwani, “Extracting Schema from Semistructured Data”, Proceedings of the ACM International Conference on Management of Data (SIGMOD '98), pp.165-176, 1988, and K. Wang and H. Liu, “Discovering Structural Association of Semistructured Data”, IEEE Transactions on Knowledge and Data Engineering, Vol. 12(3): pp. 353-371, May/June 2000). Of particular relevance to PIPE is the algorithm of Nestorov et al., supra, whose modeling of semistructure closely resembles the representation of an interaction sequence in terms of program variables. This algorithm works by identifying graph constructs that could be factored, simplified, or approximated. FIGS. 9A, 9B, 9C, and 9D illustrate four stages in a procedure for program compaction. The starting point is the schema in FIG. 9A obtained by a naive crawl of a site. FIG. 9B factors commonalities encountered in crawling. There are only three leaf nodes and the internal nodes P3 and P4 are collapsed because they are really the same page. FIG. 9C is a “minimal perfect typing” (from Nestorov et al., supra) of the data, which means that the fewest internal nodes needed to describe the schema are used. In this example, P1 and P2 are collapsed, not because they are the same but because they exhibit the same schema. Both have an incoming edge labeled e from the same type of page (S2) and display an outgoing edge labeled i to the same type of page (M1). While their contents may not be the same, interaction sequences involving them can be compacted. Care must be taken to ensure that any accompanying text with these nodes are not lost. And finally, FIG. 9D casts P6 as redundant for the purpose of modeling interaction sequences. The role of P6 in FIG. 9D is to establish connections from S5 to M2 and M3, which are already embodied in P5 and P7 respectively. Thus, P6 can be removed, once again after ensuring that any contents of that node are suitably represented elsewhere. In Nestorov et al., supra, PG is referred to as a node that exhibits “multiple roles”.

There are now described two applications that use PIPE to personalize collections of web sites. They are presented in increasing order of complexity, as evidenced by the forms of modeling they conduct (see Table 1). In each of these applications, the conceptual model of interaction sequences and the specific choices made in modeling are stated. Evaluation results are presented in N. Ramakrishnan and S. Perugini, “The Partial Evaluation Approach to Information Personalization”, Technical Report cs.IR/0108003, Computing Research Repository (CoRR), August 2001. Since PIPE only specializes representations, it is possible to personalize even third-party sites by forming suitable representations. More personalization systems designed with PIPE are described in N. Ramakrishnan, “PIPE: Web Personalization by Partial Evaluation”, IEEE Internet Computing, Vol. 4(6): pp. 21-31, November-December 2000, and N. Ramakrishnan, M. B. Rosson, and J. M. Carroll, “Explaining Scenarios for Information Personalization”, ACM Transactions on Computer-Human Interaction, August 2001. Only two are presented here for space considerations.

TABLE 1
Modeling options used in the application case studies.

| | |
|---|---|
| Congressional Officials | Modeling Site Structure |
| Mathematical and Scientific | Modeling within a Page |
| Software | Modeling Site Structure |
| | Interacting with Recommender |
| | Systems |
| | Information Integration |
| | Modeling within a Page |
| | Program Compaction |

The first application customizes access to the Project Vote Smart website (http://www.vote-smart.org), an independent resource for information about United States governmental officials. The site caters to people interested in politicians' backgrounds, committee memberships, and positions on major political issues. While Project Vote Smart reports on state and local governments as well as the federal government, the focus was on only on the congressional subsection of the site in the experiments.

The conceptual model of information-seeking involves browsing through the congressional subsection to retrieve individual web pages of politicians. Interaction sequences at this site consist of choices of state (e.g., California, Virginia, etc.), branch of congress (House or Senate), party (Democrat, Republican, or Independent), and district information (numbers of districts). The terminal information involved 540 home pages (for 100 Senate members and 440 House members) and resides at the ends of interaction sequences.

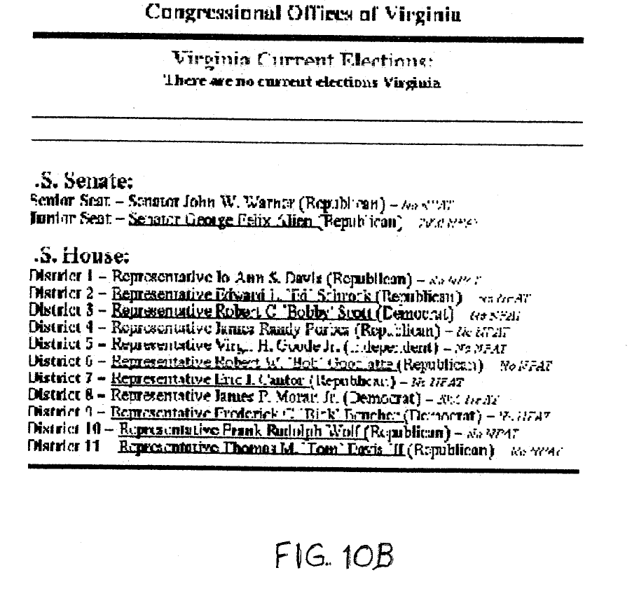

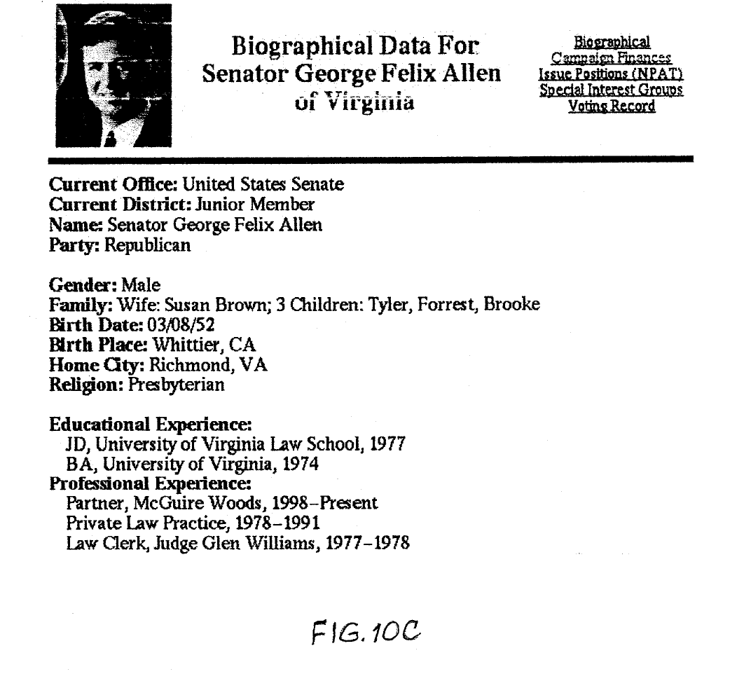

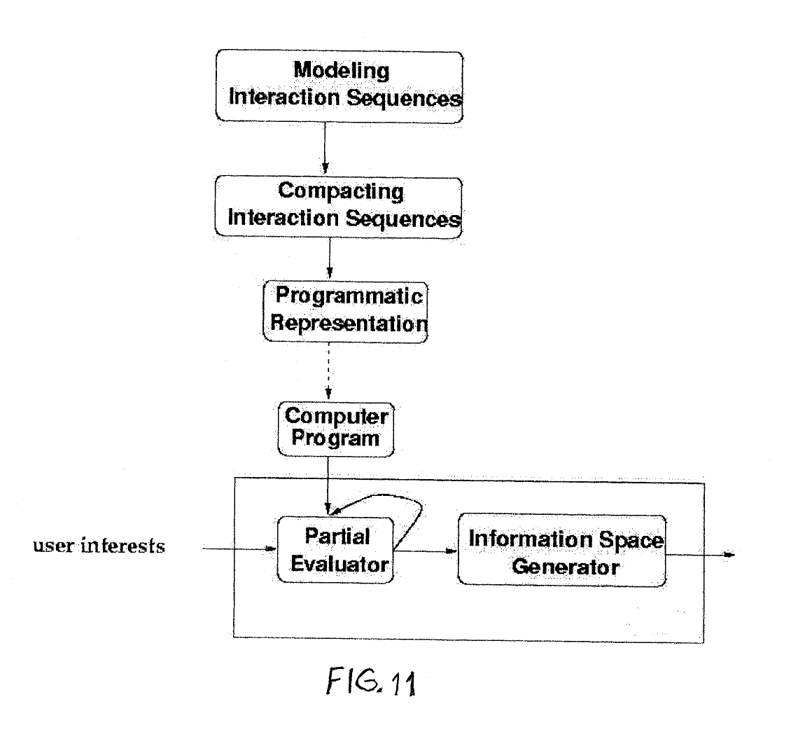

FIGS. 10A, 10B, and 10C illustrate a typical interaction sequence. At the root congressional page (FIG. 10A), users are directed to select a state of interest. Selection of state transfers the user to that particular state's web page (FIG. 10B). A state web page is semi-structured, listing both senators and representatives as well as their party, district affiliations, and other associated information. Finally, a user arrives at a politician's web page (FIG. 10C) by making a selection at the state page. Thus, the congressional section of Project Vote Smart is three levels deep (with a two-step interaction sequence).

Since many of the choices made by the user in browsing through Project Vote Smart are independent of each other (e.g., selecting Virginia as state does not imply a particular political party), the site is highly amenable to personalization by partial evaluation. Currently the site hardwires interaction sequences in the order shown in FIGS. 10A to 10C The two-step interaction sequence (as shown in FIGS. 10A to 10C) was actually modeled as a four-step interaction sequence by conducting a more detailed modeling of the state-level page. In particular, the semistructure on state-level pages was abstracted to yield independently addressable information about branch of congress, party, and district.

The site graph is not a balanced tree. For instance, every state has exactly two senators but the number of representatives varies from 1 in South Dakota to 52 in California (this is dependent on state population). The modeling of data at state pages expanded the original 3-level tree shown in FIG. 10A consisting of 596 nodes (1 root page plus 55 state pages plus the previously mentioned 540 leaves of the tree) to 5 levels comprising 857 nodes (317 internal nodes plus 540 leaf nodes). This amounts to a approximately 44% percent explosion in the site schema.

The programmatic representation of the new site schema was in the C programming language and it captured miscellaneous domain semantics about interaction at the site (e.g., if the user says “District 21”, he is referring to a Representative, not a Senator). The partial evaluator C-Mix was used for this study.

The second application is a personalization system for recommending mathematical software on the web for scientists and engineers. Consider a scientist studying stress in a helical spring. He or she formulates the problem mathematically in terms of a partial differential equation (PDE) and proceeds to find software that can help in solving his or her PDE. He or she uses a collection of three web sites to conduct his information-seeking activity.

First, he or she accesses the GAMS (Guide to Available Mathematical Software) cross-index of mathematical software (http://gams.nist.gov), a tree-structured taxonomy that covers nearly 10,000 algorithms (from over 100 software packages) for most areas of scientific software. GAMS functions in an interactive fashion, guiding the user from the top of a classification tree to specific modules as the user describes his problem in increasing detail. During this process, many important features of the software (e.g., “are you looking for a software to solve elliptic problems?”) are determined, from the user. However at the ends of the interaction sequences at GAMS, there still exist several choices of algorithms for a specific problem. Now, the scientist consults a recommender system or a performance database server (for his category of scientific software) to pick an appropriate algorithm for his problem. An example is the PYTHIA recommender system for selecting solvers for PDEs (see E. N. Houstis, A. C. Catlin, J. R. Rice, V. S. Verykios, N. Ramakrishnan, C. E. Houstis, “PYTHIA-II: A Knowledge/Database System for Managing Performance Data and Recommending Scientific Software”, ACM Transactions on Mathematical Software, Vol. 26(2): pp. 227-253, June 2000). At this point, the scientist supplies additional information to the recommender such as his performance constraints (on the time to solve his PDE). Systems like PYTHIA use previously archived performance data to arrive at recommendations such as “Use the second-order 9-point finite differences code from the ELLPACK module”. After such a recommendation, the scientist conducts the final step of downloading the recommended software module from repositories such as Netlib (http://www.netlib.org) housed at the Oak Ridge National Laboratory (ORNL) or other packages at the National Institute of Standards and Technology (NIST). The conceptual model involved the information flow from the GAMS site, to a repository such as Netlib, through a recommender such as PYTHIA.

The choices made in GAMS will affect the choice of recommender which in turn affect the choice of repository. This application thus presents an interesting information flow for modeling. Since PIPE permits partial instantiation of the information flow, the scientist can directly access a repository such as Netlib if he is sure of the specific software he needs.

The entire GAMS web site was modeled, the PYTHIA recommender (that addresses software for the domain of PDEs) was used, and connections with individual software modules at the various repositories were established. After an initial expansion of GAMS (e.g., by within-page modeling), the program compaction algorithm described in above was applied. Cross-references in GAMS and duplication of common module sets (which are now revealed by the initial expansion) helped compress the site schema to sixty percent of its original size. rn particular, the GAMS subtree relevant to describing PDEs provided for a eleven percent compression. There was no terminal information alongside intermediate nodes, and hence there was no need for any special handling. PYTTIA's details are described in E. N. Houstis et al., supra, and a white-box modeling in PIPE was conducted to better associate program variables from GAMS with variables in PYTHIA. Finally, the step to reach individual software modules was a simple one-step interaction sequence leading to terminal information about the code (in FORTRAN) and its documentation. The entire composite program was represented in the CLIPS programming language (see J. C. Giarratano, Expert Systems: Principles and Programming, Brooks/Cole Publishing, 1998) and its rule-based interface for partial evaluation was employed. More modeling details on this case study can be found in S. Perugini, P. Lakshimarayanan, and N. Ramakrishnan, “Personalizing the GAMS Cross-Index”, Technical Report TR-00-01, Department of Computer Science, Virginia Tech, March 2000.

As a systematic methodology for personalization, PIPE is a unique invention. Most work on personalization emphasizes the nature of information being modeled (content-based versus collaborative), the level at which the personalized information is targeted (is it by user, by topic or for everybody), or the specific algorithms that are involved in making recommendations.

In contrast, PIPE models interaction with an information system as the basis for personalization. Most of recommender systems research can be viewed as modeling options for PIPE. The systems that make distinctions among targeting constitute making different assumptions on the possible set of interaction sequences. They can hence be tied to requirements analysis, as described in N. Ramakrishnan et al, supra. Systems that conduct web usage mining also address the earlier parts (and sometimes, later parts) of the personalization system design lifecycle, and can be viewed as methodologies to suggest and refine interaction sequences.

Other connections to information systems research can be made by observing that PIPE contributes both a way to model information-seeking activities as well as a closed transformation operator for personalization i.e., partial evaluation. RABBIT (M. D. Williams, supra) is an early interactive information retrieval methodology that resembles PIPE in this respect. It proposes the model of “retrieval by reformulation” to address the mismatch between how an information space is organized and how a particular user forages in it. Several closed transformation operators are provided in RABBIT to enable the user to specify and realize information-seeking goals. Like RABBIT, PIPE assumes that the user knows more about the generic structure of the information space than PIPE does, although PIPE knows more about the particulars (terminal information). For instance, personalization by partial evaluation is only as effective as the ease with which program variables could be set (on or off) based on information supplied by the user. Unlike RABBIT, PIPE emphasizes the modeling of an information space as well as an information-seeking activity in a unified programmatic representation. Its single transformation operator is expressive enough to simplify a variety of interaction sequences.

The closed nature of transformation operators is central to interactive modes of information seeking, as shown in projects such as Scatter-Gather (D. R. Cutting, D. Karger, J. Pedersen, and J. W. Tukey, “Scatter/Gather: A Cluster-Related Approach to Browsing Large Document Collections”, Proceedings of the Fifteenth Annual International Conference on Research and Development in Information Retrieval (SIGIR), pp. 318-329, Copenhagen, Denmark, June 1992) and Dynamic Taxonomies (G. M. Sacco, “Dynamic Taxonomies: A Model for Large Information Bases”, IEEE Transactions on Knowledge and Data Engineering, Vol. 12(3): pp. 468-479, May/June 2000). PIPE is novel in that it contributes a transformation operator for representations of interactions in information spaces, and does not transform documents or web pages directly.

The “larger” approach to personalization taken in this invention is reminiscent of the integration of task models in software design. Typically such integration has utilized object oriented methodologies and symbolic modeling approaches e.g., Unified Modeling Language (UML). This idea has been used for designing personalization systems as well. However, in such projects, personalization is introduced a function from the conceptual design stage. PIPE's support for personalization. on the other hand, is built into the programmatic model of the information space and does not require any special handling.

The flow diagram of FIG. 11 illustrates the steps of the PIPE methodology/process. The methodology personalizes interactions with information systems by creating a programmatic representation of interaction and uses the technique of partial evaluation to personalize for a user's known interests or information seeking activity. Since the methodology's power relies solely on the programmatic representation, any information system technology that permits programmatic modeling can be personalized with PIPE.

The first step in the process is modeling interaction sequences. In this step, interactions with the information system are modeled as a set of interaction sequences in which each interaction sequence denotes a possible dialog between the user and the information system. A dialog is viewed as a task-oriented information-seeking activity involving a list of information-seeking aspects. In particular, the dialog is seen as one where the user specifies one or more information aspects, and the system responds with one or more information aspects. The aspects that the user specifies are called “structural aspects” and aspects that the system responds with are called “terminal aspects” (i.e., the terminal aspects are what the user was looking for, in the first place).

There are several ways in which the user can communicate structural aspects and there are several ways in which the system can communicate back terminal aspects. For instance, structural aspects can be described using facilities afforded by the technology, such as “clicking on hyperlinks”, “talking into a microphone”, “touching keypads”, or “filling in forms”. Terminal aspects, again, can be described using technological implementations such as “presenting a web page in answer”, “voicing back responses”, and “showing information”. In the PIPE methodology, these particular technological means of facilitating the communication of structural and terminal information are not modeled. The distinction between interactions at the level of “clicking”, “talking”, etc., is thus not made. Interaction sequences are only characterized in terms of the information aspects, and not how the information aspects are supported by the underlying technology.

For instance, in a web site that has information about automobiles, let us say interactions proceed by the user clicking on a choice of model, followed by a choice of year, followed by a choice of color. The structural information is, therefore, the specific choices made by the user of model, year, and color. The terminal information is what the system presents after the user has made these choices. For instance, the terminal information could be a web page that the system presents about the availability of cars that meet the user's specifications. The modeling only involves structural and terminal aspects and does not recognize the fact that “structural aspects were communicated by the user clicking on links” and “terminal aspects were communicated by the system presenting a web page in return”.

At the end of this step, there are a number of interaction sequences that describe possible interactions with an information system. For instance, a set of interaction sequences for the above web site could be:

1. The structural aspect of “Blue” is specified, and then the structural aspect of “2001” is specified, and then the structural aspect of “Honda” is specified, and then the terminal aspect of “availability of Blue Honda 2001 cars” is presented back.

2. The structural aspect of “Red” is specified, and then the structural aspect of “2001” is specified, and then the structural aspect of “Honda” is specified, and then the terminal aspect of “availability of Red Honda 2001 cars” is presented back.

Other possible interaction sequences will readily suggest themselves to the reader.

The next step in the PIPE methodology/process shown in FIG. 14 is compacting interaction sequences. This step is optional. Its purpose is to compact the set of interaction sequences to determine a new set of interaction sequences that has fewer states. Any standard algorithm for state minimization or schema compression can be utilized for this step. One way to do this is the procedure shown in FIG. 10.

At the end of this step, there is produced a set of interaction sequences that compactly describe interactions with an information system. For instance, following the above example, this step might produce:

3. The structural aspect of “Blue” or “Red” is made for color, and then the structural aspect of “2001” or “2000” is made for year, and then the structural aspect of “Honda” or “Toyota” is made for model, and then the terminal aspect of “availability of <color> <year> <model> cars” is presented back.

The next step in the PIPE methodology/process shown in FIG. 14 is the programmatic representation of interactions sequences. This step involves the representation of the set of interaction sequences as a computer program. The programming language thus serves as the representation language. Any imperative programming language can be used, such as C, Pascal, FORTRAN, and BASIC.

The several substeps of this step are as follows:

1. Define a program variable for each structural aspect. These are called structural variables.

2. Define a program variable for each terminal aspect. These are called terminal variables.

3. Organize the set of interaction sequences in terms of conditional elements on structural variables, using the constructs provided in the programming language. For example, the C programming language conditional construct if . . . else can be used if the choice of representation language is C.

4. Declare all structural variables to be parameters in the program.

5. If an interaction sequence produces values for terminal aspects, the corresponding programmatic representation should assign values for (respective) terminal variables.

At the end of the programmatic representation step, there is produced a computer program that captures how interactions proceed with the information system.

The next step in the PIPE methodology/process shown in FIG. 14 is creating a personalization system. This step takes the computer program created in the previous step and uses it to form the basis of a presentation system. This step uses a partial evaluator and an information space generator to complete the system design.

A partial evaluator is a source-to-source transformation engine that simplifies programs given values for some program variables, as described in the paper “An Introduction to Partial Evaluation” by Neil D. Jones, supra.

An information space generator provides the mapping from the simplified program to the information space, using the appropriate information system technology. For instance, if the technology is web sites, the specialized program would be rendered in terms of hyperlinks and web pages. If the technology is voice-activated, the specialized program would be rendered in spoken dialog. If the technology is touch-screen keypads, the specialized program would be rendered as a new screen to be touched by the user. If the technology is a networked directory access protocol, the specialized program would be rendered as a new directory access session.

In summary, PIPE achieves personalization. When a user specifies his or her information-seeking aspects or interests, they are represented as values for structural program variables. Partial evaluation is done with respect to those variables, and the resulting program is converted back to an information space, which is presented back to the user. The new information space is more personalized since the interactions that deal with the aspects specified by the user have been simplified by partial evaluation.

PIPE covers various information system technologies. This is addressed by modeling of all interactions as interaction sequences in a program. So, the details of how the particular technology supports the interaction are abstracted out in the modeling.

PIPE achieves mixed-initiative interaction. When the user does not like the choices currently presented by the information system, he or she can proceed to specify any structural aspect out of turn which is processed by partially evaluating with respect to the structural program variable. In other words, the personalization system is still responsive to the user when the user takes the initiative. This aids the system to realize mixed-initiative interaction.

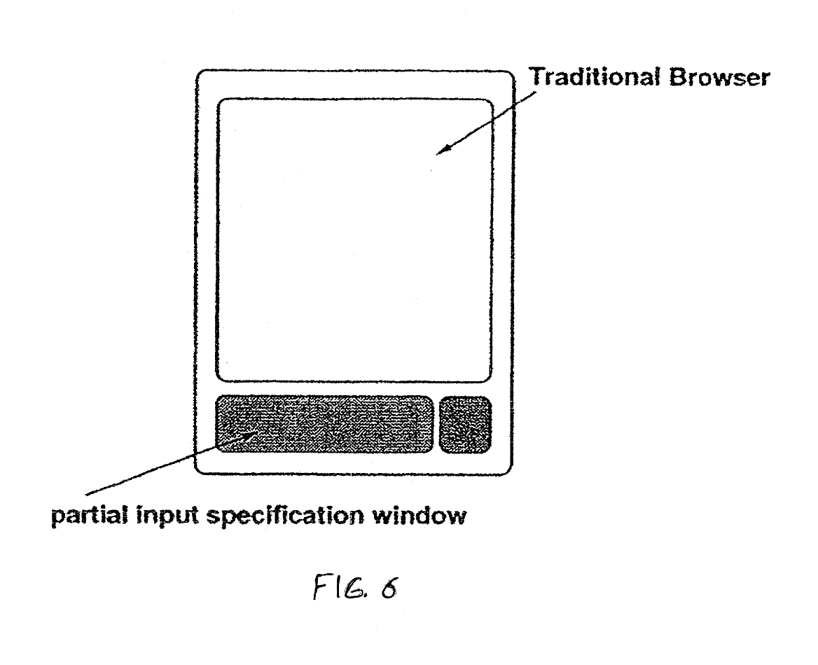

The PIPE interface design supports personalization. Since partial evaluation of a program can be done in many ways, it is not necessary to pre-identify the ways in which the user might specify his or her information-seeking aspects. Irrespective of what the user specifies, the action is the same—namely, “partial evaluation”. So, the interface design is simple and only involves two windows (see FIG. 6). One window is if the user wants to proceed with the interaction along the lines initiated by the information system. The other window is if the user would like to take the initiative and personalize his or her interaction by specifying some structural aspect out-of-turn. In addition, since these two windows are available throughout an interaction session, the user can mix and match them to suit his or her information-seeking preferences.

This invention makes several major contributions. A novel modeling methodology has been presented for information personalization. PIPE enables the view of personalization as specializing representations. It models interactions with information systems and uses partial evaluation to simplify the interactions. While only web sites have been covered (and collections of web sites) in the description of the preferred embodiment of the invention, any information system technology that affords the notion of interaction sequence can be supported on similar lines. This especially applies to designs for voice-activated systems (e.g., Voice eXensible Markup Language or VoiceXML), directory access protocols (e.g., Lightweight Directory Access Protocol or LDAP), information systems that provide a dialog model of interaction, and models for organizing digital libraries (e.g., 5S).

Thus, while the invention has been described in terms of computerized information systems applied to web sites in a preferred embodiment, those skilled in the art will recognize that the invention can be practiced with modification and applied to many forms of computerized information systems within the spirit and scope of the appended claims.

Having thus described my invention, what I claim as new and desire to secure by Letters Patent is as follows:

1. A systematic modeling methodology for information personalization in an information system which automatically adjusts information content, structure, and presentation to an individual user comprising the steps of:
modeling information-seeking interaction sequences with the information system wherein each interaction sequence denotes a possible dialog between the user and the information system;
programmatically representing the interaction sequences in a computer program;
creating a personalization system by partial evaluation of the computer program to produce a simplified program; and
generating a personalized information space for the user in a user interface from the simplified program.

2. The systematic modeling methodology for information personalization in an information system recited in claim 1, wherein a dialog in the step of modeling is a task-oriented information-seeking activity involving a list of information-seeking aspects comprising structural aspects specified by the user and terminal aspects as responses by the information system to the specified structural aspects.

3. The systematic modeling methodology for information personalization in an information system recited in claim 2, wherein the step of generating a computer program comprises the steps of:
defining a program variable for each structural aspect, called structural variables;
defining a program variable for each terminal aspect, called terminal variables;
organizing the set of interaction sequences in terms of conditional elements on structural variables, using constructs provided in a programming language;
declaring all structural variables to be parameters in the program; and
if an interaction sequence produces values for terminal aspects, assigning values for respective terminal variables in corresponding programmatic representation.

4. The systematic modeling methodology for information personalization in an information system recited in claim 1, further comprising the step of compacting interaction sequences to determine a new set of interaction sequences having fewer states prior to the step of programmatically representing the interaction sequences in a computer program.

5. The systematic modeling methodology for information personalization in an information system recited in claim 1, wherein the step of creating a personalization system by partial evaluation of the computer program uses a source-to-source transformation engine that simplifies the computer program for static values of some program variables.

6. The systematic modeling methodology for information personalization in an information system recited in claim 1, where in the step of generating a personalized information space for the user in a user interface is performed by mapping from the simplified program to the information space, in terms of a technology corresponding to the information system.

7. The systematic modeling methodology for information personalization in an information system recited in claim 6, wherein the information-seeking interaction of the user is by means of a browser.

8. The systematic modeling methodology for information personalization in an information system recited in claim 7, wherein the user interface is a browser window displaying an information space and a partial input specification window for facilitating user interaction.

9. The systematic modeling methodology for information personalization in an information system recited in claim 7, wherein the browser supports a browsing hierarchy, said step of modeling being performed using a nested programmatic model.

10. The systematic modeling methodology for information personalization in an information system recited in claim 7, wherein the user interface comprises two windows, a first window allowing the user to proceed with an interaction along lines initiated by the information system and a second window allowing the user to take an initiative and personalize the interaction by specifying some aspect out-of-turn.

11. The systematic modeling methodology for information personalization in an information system recited in claim 1, wherein the user can specify any aspect out-of-turn, further comprising the step of partially evaluating the program with respect to values for structural program variables.

12. The systematic modeling methodology for information personalization in an information system recited in claim 7, further comprising the steps of:
when a user specifies information-seeking aspects, representing the information-seeking aspects as values for structural program variables;
performing a partial evaluation with respect to the structural program variables; and
converting a resulting program back to the information space.
